(19) United States
(12) Patent Application Publication
(10) Pub. No.: US 2025/0345234 A1
(43) Pub. Date: Nov. 13, 2025

(54) GAS-TYPE LYMPHATIC DRAINAGE DEVICE

(71) Applicant: TECHNO TAKATSUKI CO., LTD., Osaka (JP)

(72) Inventor: Kazuma SHIMIZU, Osaka (JP)

(21) Appl. No.: 18/988,905

(22) Filed: Dec. 20, 2024

(30) Foreign Application Priority Data
May 10, 2024 (JP) 2024-077115

(51) Int. Cl. A61H 9/00

(52) U.S. Cl. CPC A61H 9/0078

(57) ABSTRACT

A gas-type lymphatic drainage device includes a first lymphatic drainage member and a second lymphatic drainage member connected to the first lymphatic drainage member, in which the first lymphatic drainage member includes a first gas chamber expandable and contractible, the second lymphatic drainage member includes a gas chamber group containing gas chambers independently expandable and contractible, the first gas chamber includes a first portion configured to cover at least a part of a lower abdomen of a human body, a second portion extending along a gluteal cleft of the human body, and a third portion located between the first portion and the second portion and configured to cover a crotch of the human body, and when the first gas chamber expands, at least a part of a central portion of the third portion is recessed.

### CROSS-REFERENCE TO RELATED APPLICATION

This application is based upon and claims the benefit of priority from Japanese Patent Application No. 2024-77115, filed on May 10, 2024, the entire contents of which are incorporated herein by reference.

### TECHNICAL FIELD

The present disclosure relates to a gas-type lymphatic drainage device.

### BACKGROUND

A gas-type massage machine (an air massage machine) using supply and discharge of compressed air has been known as a type of massage machine for fatigue recovery, blood circulation promotion, and the like. Japanese Unexamined Patent Publication No. 2019-141222 describes a pneumatic massage device mounted around a body trunk including a waist. The pneumatic massage device includes a pair of pressing prevention air chambers provided close to left and right side edges of a waist peripheral portion. When a waist air chamber expands and a main body of the massage device is pulled rearward, the pressing prevention air chambers support a lower abdomen peripheral portion to prevent the lower abdomen peripheral portion from pressing a lower abdomen of a wearer.

### SUMMARY

A massage machine or the like disclosed in Japanese Unexamined Patent Publication No. 2019-141222 may be used to promote flow of body fluid such as lymph fluid to a torso. However, in the massage machine or the like originally intended to promote blood circulation or the like, the body fluid may flow to a place different from an intended location (for example, a portion other than the torso). In this case, retention of the body fluid in an unintended location may be promoted.

An example gas-type lymphatic drainage device according to one aspect of the present disclosure is a gas-type lymphatic drainage device for flowing lymph fluid of a lower limb of a human body toward a torso by using a gas, the gas-type lymphatic drainage device including: a first lymphatic drainage member having a pant-like shape; a second lymphatic drainage member having a boot-like shape, the second lymphatic drainage member being connected to the first lymphatic drainage member; and a gas supply/discharge system configured to supply or discharge a gas to or from each of the first lymphatic drainage member and the second lymphatic drainage member, in which the first lymphatic drainage member includes a first gas chamber expandable and contractible, the second lymphatic drainage member includes a gas chamber group containing gas chambers independently expandable and contractible, the first gas chamber includes a first portion configured to cover at least a part of a lower abdomen of the human body, a second portion configured to extend along a gluteal cleft of the human body, and a third portion located between the first portion and the second portion, the third portion being configured to cover a crotch of the human body, and when the first gas chamber expands, at least a part of a central portion of the third portion is recessed.

In the gas-type lymphatic drainage device, the first gas chamber included in the first lymphatic drainage member contains the first portion configured to cover at least a part of the lower abdomen of the human body, the second portion configured to extend along the gluteal cleft of the human body, and the third portion located between the first portion and the second portion and configured to cover the crotch of the human body. Here, when the first gas chamber expands, at least a part of the central portion of the third portion is recessed. Thus, since both sides of the crotch are favorably pressed by the third portion of the first gas chamber, inflow of the lymph fluid flowing from the lower limb of the human body toward the torso from flowing into the crotch of the human body can be favorably prevented by the second lymphatic drainage member. Therefore, the flow of the lymph fluid to the intended location by using the gas-type lymphatic drainage device can be promoted.

When the first gas chamber expands, at least a portion close to the first portion in the central portion of the third portion may be recessed. In this case, when the first gas chamber expands, the third portion can favorably press the crotch and a groin.

When the first gas chamber expands, at least a part of a central portion of the first portion may be recessed. In this case, when the first gas chamber expands, a pubic region of the human body is less likely to be pressed by the first gas chamber.

The first gas chamber may include an expansion suppressing portion extending from the central portion of the first portion toward the central portion of the third portion. In this case, when the first gas chamber expands, the first gas chamber can more favorably press the crotch and the groin. Further, in the expansion suppressing portion, a ceiling and a bottom of the first gas chamber may be joined to each other.

The first gas chamber may include a pair of pads provided on the ceiling of the first gas chamber, and the central portion of the third portion may be located between the pair of pads. In this case, when the first gas chamber expands, the both sides of the crotch can be more favorably pressed by the pair of pads.

The gas chamber group may include a second gas chamber configured to cover at least a part of a foot of the human body, the second gas chamber may include a fourth portion configured to cover at least a part of a sole of the human body, a fifth portion configured to cover at least a part of a dorsum pedis of the human body, a sixth portion configured to cover at least a part of a foot side surface of the human body, and a second expansion suppressing portion configured to suppress expansion of the sixth portion, and the sixth portion may connect the fourth portion and the fifth portion. In this case, when the second gas chamber expands, the foot side surface of the human body is less likely to be pressed. Further, in the second expansion suppressing portion, a ceiling and a bottom of the second gas chamber may be joined to each other.

The second gas chamber may further include a third expansion suppressing portion configured to suppress expansion of a part of the fourth portion. In this case, only an intended portion of the sole of the human body can be pressed.

### BRIEF DESCRIPTION OF THE DRAWINGS

FIG. 1 is a schematic perspective view illustrating an example lymphatic drainage device.

FIG. 2 is a schematic perspective view of a first lymphatic drainage member as viewed from the front.

FIG. 3 is a schematic perspective view of the first lymphatic drainage member as viewed from the rear.

FIG. 4A is a schematic perspective view of a gas chamber before expansion as viewed from the front, and FIG. 4B is a schematic perspective view of the gas chamber before expansion as viewed from a bottom surface.

FIG. 5A is a schematic perspective view illustrating the gas chamber after expansion, and FIG. 5B is a schematic perspective view of the gas chamber after expansion as viewed from side.

FIG. 6A is a schematic view illustrating the gas chamber during use, and FIG. 6B is a schematic view of a main part illustrating the gas chamber during use.

FIG. 7 is a schematic perspective view of a second lymphatic drainage member as viewed from the front.

FIG. 8A is a schematic view illustrating a position of a lymphatic vessel group in a lower leg of a human body as viewed from a front right side, FIG. 8B is a schematic view illustrating the position of the lymphatic vessel group in the lower leg of the human body as viewed from left side, and FIG. 8C is a schematic view illustrating the position of the lymphatic vessel group in the lower leg of the human body as viewed from the rear.

FIG. 9A is a schematic perspective view of an end gas chamber before expansion as viewed from the front, and FIG. 9B is a schematic perspective view of the end gas chamber before expansion as viewed from the bottom surface.

FIG. 10A is a schematic perspective view illustrating the end gas chamber after expansion, and FIG. 10B is a schematic side view illustrating the end gas chamber during use.

FIG. 11 is a schematic block diagram of a gas supply/discharge system.

FIG. 12 is a schematic perspective view illustrating the lymphatic drainage device according to another example.

### DETAILED DESCRIPTION

Hereinafter, examples will be described in detail with reference to the accompanying drawings. Note that in the following description, the same reference numerals will be used for the same elements or elements having the same functions, and redundant description will be omitted.

An example gas-type lymphatic drainage device is capable of promoting flow of lymph fluid retained in a body of a subject to a desired position using a gas. The gas-type lymphatic drainage device is used, for example, for stimulating the body of the subject, such as “massaging” the body of the subject, for improving a physical condition, such as improving retention of a vein of the subject, in addition to the lymph fluid. Here, the term “gas” may be a gas having a pressure higher than an atmospheric pressure. In some examples, the gas is air from the viewpoint of convenience. However, the gas is not particularly limited, and may be an inert gas such as helium (He) and nitrogen (N₂), or may be a gas such as oxygen (O₂).

The term “axial direction” may refer to a direction in which a lower limb of a human body to which the gas-type lymphatic drainage device is attached extends from a torso, the term “circumferential direction” may refer to a direction going around the axial direction, and the term “radial direction” may refer to a direction intersecting the axial direction (for example, a direction perpendicular to the axial direction). An expression “proximal” and similar expressions may refer to a direction approaching a heart of the human body unless otherwise specified, and an expression “distal” and similar expressions may refer to a direction away from the heart of the human body (a direction opposite to “proximal”) unless otherwise specified. An expression “up” and similar expressions may refer to a direction from toes to a head in the human body, and an expression “down” and similar expressions may refer to a direction from the head to the toes (a direction opposite to “up”) in the human body. An expression “front” and similar expressions may refer to a direction in which an abdomen of the human body faces, and an expression “rear” and similar expressions may refer to a direction in which buttocks of the human body face (a direction opposite to “front”). An expression “right” and similar expressions may refer to a left direction when the human body is viewed from the front, and an expression “left” and similar expressions may refer to a right direction (a direction opposite to “right”) when the human body is viewed from the front. An expression “inside” and similar expressions may refer to a direction in which left and right legs face each other, and an expression “outside” and similar expressions may refer to a direction in which the left and right legs move away from each other (a direction opposite to “inside”).

The “lower limb” and the “leg” may refer to a region from the crotch to the toe (an entire portion distal to the torso), and a “foot” may refer to a region from an ankle to the toe (an entire portion distal to the ankle). The term “connection” is not limited to a simple physical connection. For example, when a fluid such as a gas or liquid flows between two devices via an intermediate member such as a hose, a tube, or a tank, the two devices are considered to be connected (e.g., fluidly connected of fluidly coupled) to each other. Note that a “gas chamber group” may refer to a gas chamber or an assembly of gas chambers located at a position corresponding to a specific region of a human body Z, and the number of gas chambers included in the gas chamber group may be one or more.

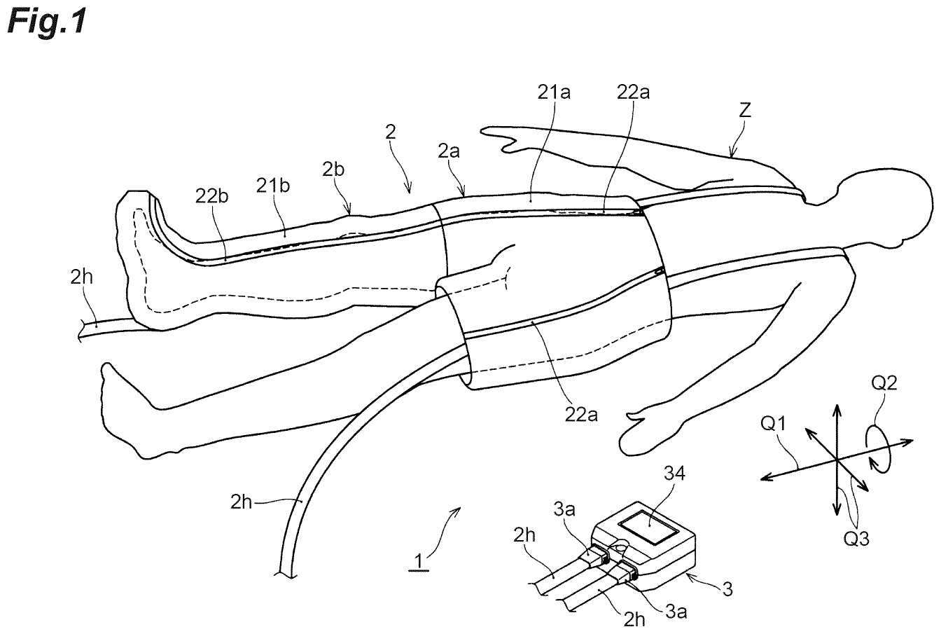

FIG. 1 is a schematic perspective view illustrating a lymphatic drainage device according to some examples. A lymphatic drainage device 1 (the gas-type lymphatic drainage device) stimulates the human body Z of the subject in order to improve retention of the lymph fluid of the subject, but is not limited thereto. For example, the lymphatic drainage device may stimulate the human body Z of the subject in order to improve retention of other body fluids such as blood of the subject. As illustrated in FIG. 1, the lymphatic drainage device 1 according to some examples is a device configured to flow the lymph fluid of the lower limb of the human body toward the torso by using the gas, and includes a main device 2 and a gas supply/discharge system 3.

The main device 2 is a device configured to be worn on the body for stimulating the subject. As illustrated in FIG. 1, the main device 2 is fluidly connected to the gas supply/discharge system 3 via a hose 2h. The main device 2 receives the gas from the gas supply/discharge system 3 to expand, and contracts as the gas is discharged through the gas supply/discharge system 3. The main device 2 presses the human body Z by expansion and releases pressure on the human body Z by contraction. The main device 2 is configured to flow the lymph fluid in the human body Z by repeatedly applying pressure to and releasing pressure from the human body Z. The main device 2 is worn in an axial direction Q1 so as to surround at least a region of the lower limb of the human body Z in a circumferential direction Q2.

As illustrated in FIG. 1, the main device 2 includes a pants-like first lymphatic drainage member 2a and a boot-like second lymphatic drainage member 2b connected to the first lymphatic drainage member 2a. The first lymphatic drainage member 2a and the second lymphatic drainage member 2b are, for example, separate from each other. In this case, the first lymphatic drainage member 2a and the second lymphatic drainage member 2b can be separately worn on the human body Z.

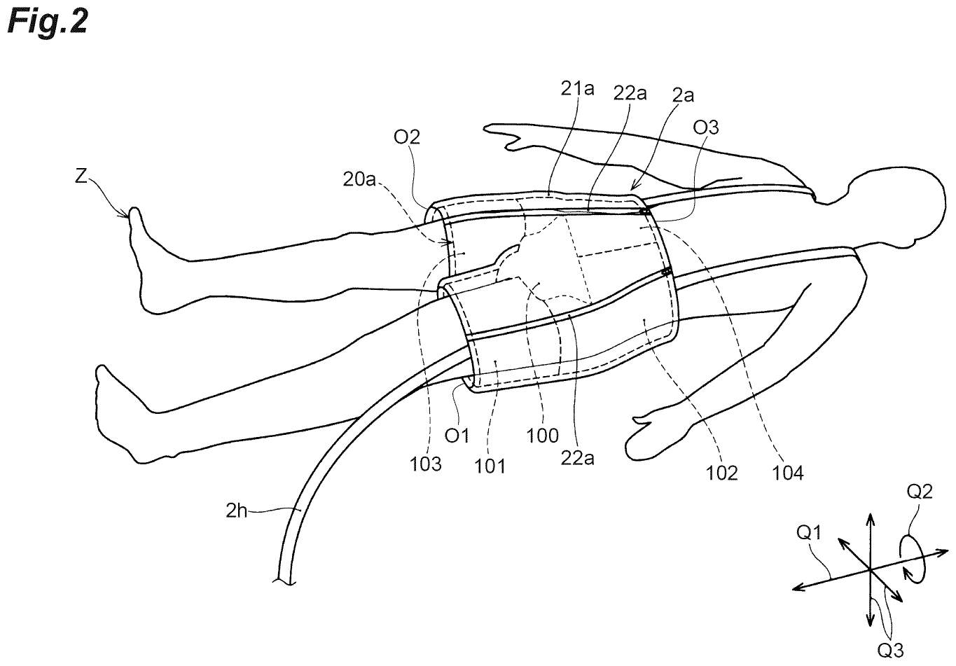

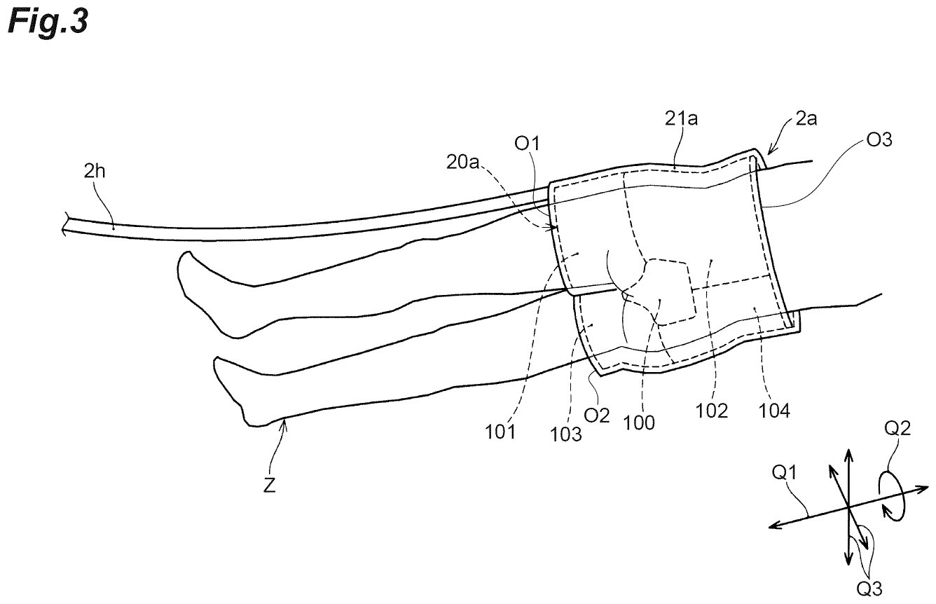

FIG. 2 is a schematic perspective view of the human body on which the first lymphatic drainage member is worn as viewed from the front. FIG. 3 is a schematic perspective view of the human body on which the first lymphatic drainage member is worn as viewed from the rear. In FIGS. 2 and 3, the human body Z inserted into the main device 2 is drawn by a solid line. As illustrated in FIGS. 2 and 3, the first lymphatic drainage member 2a is a member surrounding a periphery of a crotch of the human body Z in the circumferential direction Q2. A shape of the first lymphatic drainage member 2a is not particularly limited as long as it can be worn on the crotch of the human body Z, and is, for example, a half pants shape. The first lymphatic drainage member 2a includes two openings O1 and O2 which are located at one end in the axial direction Q1 and through which both legs of the human body Z can be inserted, and one opening O3 which is located at the other end in the axial direction Q1 and through which a waist of the human body Z can be inserted. In addition, the first lymphatic drainage member 2a includes a gas chamber group 20a, a first cover 21a surrounding the gas chamber group 20a in the circumferential direction Q2, and a first fastener 22a fastening ends of the first cover 21a in the circumferential direction Q2.

The gas chamber group 20a is an assembly of gas chambers arranged at positions corresponding to specific regions of the human body Z. The gas chamber is a member that can expand and contract independently of each other by receiving and discharging the gas. The gas chamber group 20a includes a plurality of gas chambers 100 to 104 that can expand and contract independently of each other. Each of the gas chambers 100 to 104 is, for example, a bag-like member formed by welding and sealing edges of a pair of resin films molded in advance. In some examples, one of the pair of resin films forming the gas chamber 100 functions as a ceiling of the gas chamber 100, and the other functions as a bottom of the gas chamber 100.

The gas chamber 100 (a first gas chamber) is located at a center between right and left, and extends across the front and rear of the human body Z. The gas chamber 100 may be formed in a curved strip shape extending across the front and rear so as to correspond to a branch portion for the openings O1 and O2. The gas chambers 101 and 102 are located on the left side of the human body Z, and the gas chambers 103 and 104 are located on the right side of the human body Z. The gas chamber 101 has a tubular shape corresponding to the opening O1, and the gas chamber 103 has a tubular shape corresponding to the opening O2. The gas chambers 102 and 104 are formed in one tubular shape so as to correspond to the opening O3. Each of the gas chambers 100 to 104 may have, for example, a plurality of sub-gas chambers that can expand and contract independently of each other. A positional relationship between the gas chambers 100 to 104 in the circumferential direction Q2 is not particularly limited. For example, ends of the gas chambers 100,103, and 104 in the circumferential direction Q2 may overlap each other.

A positional relationship between the gas chamber group 20a and the human body Z is not particularly limited. In some examples, as the first lymphatic drainage member 2a is worn on the human body Z such that the gas chamber 100 comes into contact with the crotch of the human body Z, the gas chamber group 20a is positioned with respect to the crotch in the axial direction Q1 and the circumferential direction Q2. In some examples, the gas chamber 100 is disposed at a position along a gluteal cleft from a center of a lower abdomen through the crotch in the human body Z. The gas chambers 101 and 103 are respectively arranged at positions corresponding to upper thighs (near the groin) of the right leg and the left leg in the human body Z. The gas chambers 102 and 104 are respectively arranged at positions corresponding to the buttocks and the waist from the lower abdomen through left and right flanks in the human body Z.

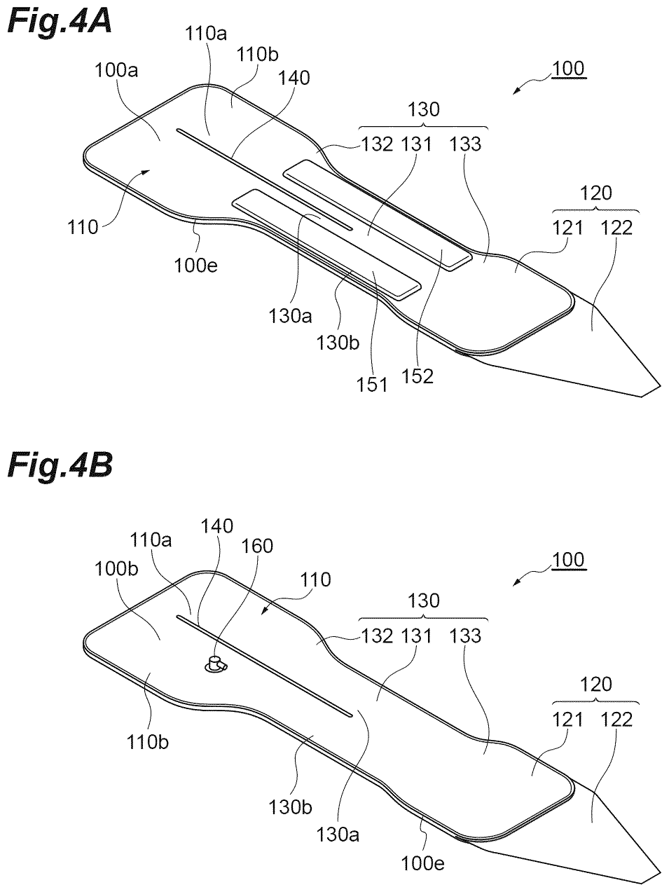

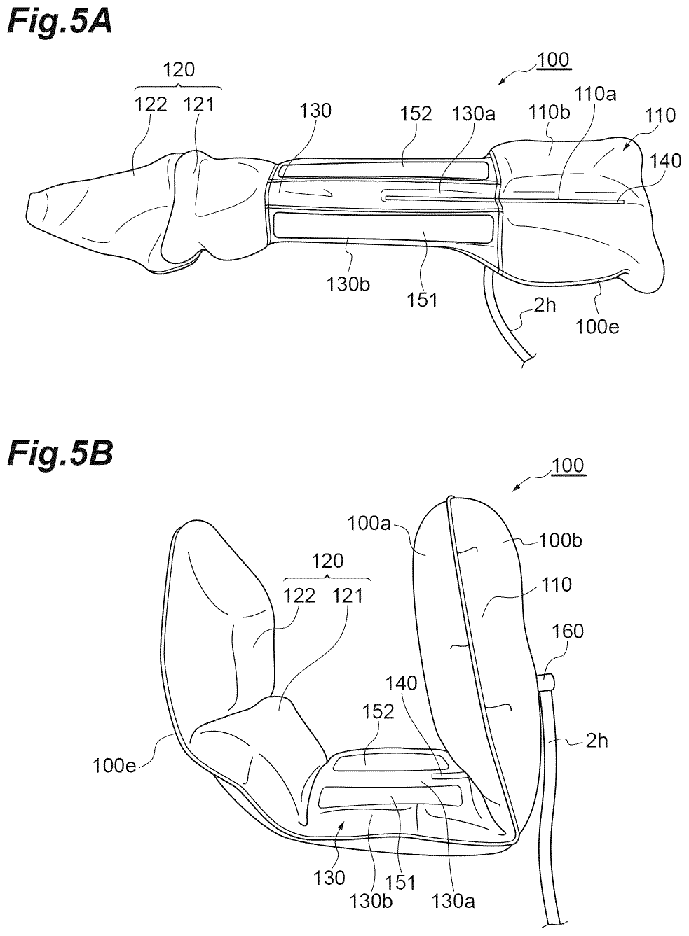

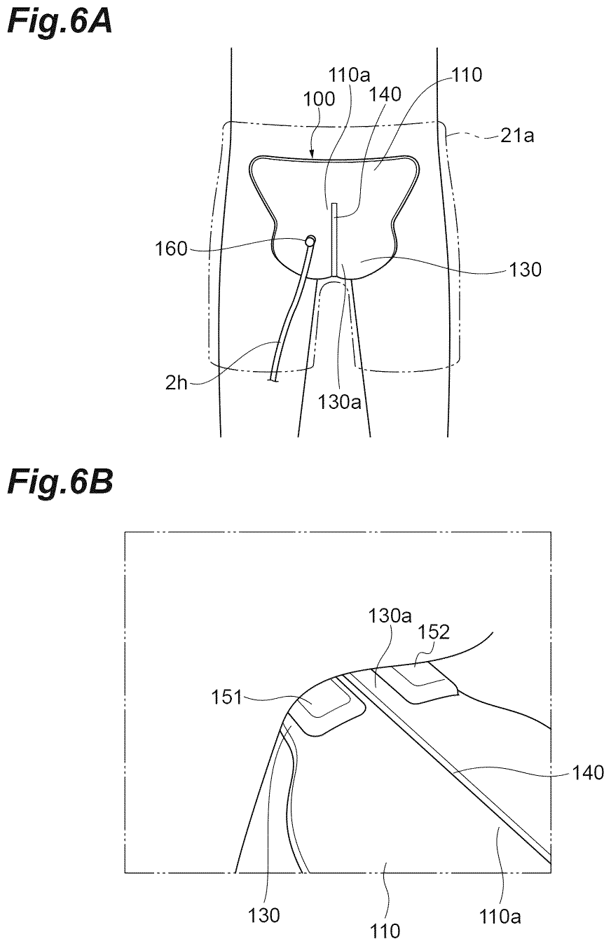

Hereinafter, the gas chamber 100 will be described in detail with reference to FIGS. 4A to 6B. FIG. 4A is a schematic perspective view of the gas chamber 100 before expansion as viewed from the front, and FIG. 4B is a schematic perspective view of the gas chamber 100 before expansion as viewed from a bottom surface. FIG. 5A is a schematic perspective view illustrating the gas chamber 100 after expansion, and FIG. 5B is a schematic perspective view of the gas chamber 100 after expansion as viewed from side. FIG. 6A is a schematic view illustrating the gas chamber 100 during use, and FIG. 6B is a schematic view of a main part illustrating the gas chamber 100 during use. As illustrated in FIGS. 4A and 4B, the gas chamber 100 is a bag-like member capable of containing gas, and is formed by a ceiling 100a and a bottom 100b which are resin films formed into a predetermined shape. The ceiling 100a is in contact with the human body Z in the gas chamber 100. For example, in the gas chamber 100, an edge 100e of the gas chamber 100 is formed by welding an edge of the ceiling 100a and an edge of the bottom 100b to each other. The gas chamber 100 includes a first portion 110, a second portion 120, and a third portion 130 arranged in a long axis direction of the gas chamber 100, an expansion suppressing portion 140, a pair of pads 151 and 152, and a gas supply/discharge port 160. An internal space of the first portion 110, an internal space of the second portion 120, and an internal space of the third portion 130 communicate with each other.

The first portion 110 is configured to cover at least a part of the lower abdomen of the human body Z, and is located on a front of the first lymphatic drainage member 2a. Before expansion of the gas chamber 100, the first portion 110 has, for example, a substantially quadrangular shape. From the viewpoint of reducing discomfort and the like, corners of the first portion 110 are rounded. As illustrated in FIG. 5A, when the gas chamber 100 expands, at least a part of a central portion 110a of the first portion 110 is recessed (additional details will be described later).

The second portion 120 extends along the gluteal cleft of the human body Z, and is located on a back of the first lymphatic drainage member 2a. The second portion 120 includes a main expansion portion 121 configured to cover at least a part of the buttocks of the human body Z and a sub expansion portion 122 extending from the main expansion portion 121 and configured to cover a part of the waist of the human body Z. The main expansion portion 121 expands by gas supply to the gas chamber 100, and is smaller than the first portion 110. Thus, excessive pressure on the buttocks by the second portion 120 is suppressed. Before the expansion of the gas chamber 100, the second portion 120 has, for example, a substantially quadrangular shape. From the viewpoint of reducing discomfort and the like, corners of the second portion 120 are rounded. The sub expansion portion 122 extends to an opposite side of the first portion 110 with the main expansion portion 121 interposed therebetween. The sub expansion portion 122 has, for example, a substantially trapezoidal shape, a substantially triangular shape, or the like.

The third portion 130 is configured to cover the crotch of the human body Z, and is located between the first portion 110 and the second portion 120 in the gas chamber 100. As illustrated in FIG. 5A, when the gas chamber 100 expands, at least a part of a central portion 130a of the third portion 130 (in some examples, at least a part of the central portion 130a of the third portion 130 close to the first portion 110) is recessed. The third portion 130 includes a main portion 131, a first connection portion 132, and a second connection portion 133.

The main portion 131 presses the crotch of the human body Z when the gas chamber 100 expands. Before the expansion of the gas chamber 100, the main portion 131 has, for example, a substantially rectangular shape. From the viewpoint of a position where the main portion 131 is disposed, a width of the main portion 131 is smaller than that of the first portion 110 and that of the main expansion portion 121 of the second portion 120. The first connection portion 132 connects the main portion 131 and the first portion 110. Before the expansion of the gas chamber 100, the first connection portion 132 has, for example, a substantially trapezoidal shape. When the gas chamber 100 expands, at least one of a boundary between the main portion 131 and the first connection portion 132 and a boundary between the first portion 110 and the first connection portion 132 can function as a fold. A width of the first connection portion 132 is narrower toward the main portion 131. The second connection portion 133 connects the main portion 131 and the second portion 120. Before the expansion of the gas chamber 100, the second connection portion 133 has, for example, a substantially trapezoidal shape. When the gas chamber 100 expands, at least one of a boundary between the main portion 131 and the second connection portion 133 and a boundary between the second portion 120 and the second connection portion 133 can function as a fold. A width of the second connection portion 133 is narrower toward the main portion 131.

The expansion suppressing portion 140 is configured to suppress expansion of a predetermined portion of the gas chamber 100, and extends from the central portion 110a of the first portion 110 toward the central portion 130a of the third portion 130. When the gas chamber 100 expands, a portion where the expansion suppressing portion 140 is provided and a periphery thereof are recessed. Therefore, in some examples, when the gas chamber 100 expands, a part of the central portion 110a of the first portion 110 and a part of the central portion 130a of the third portion 130 are recessed. Thus, an outer peripheral portion 110b surrounding the central portion 110a of the first portion 110 and an outer peripheral portion 130b surrounding the central portion 130a of the third portion 130 respectively dominantly inflates for the central portions 110a and 130a. The expansion suppressing portion 140 is a linear portion extending in the long axis direction from the central portion 110a of the first portion 110 to the main portion 131 through the first connection portion 132. The expansion suppressing portion 140 is separated from the edge 100e of the gas chamber 100. Thus, in each of the first portion 110 and the third portion 130, expansion of an unintended portion is prevented. In the expansion suppressing portion 140, the ceiling 100a and the bottom 100b of the gas chamber 100 are joined to each other. In some examples, the expansion suppressing portion 140 is formed by welding a part of the ceiling 100a and a part of the bottom 100b of the gas chamber 100 to each other. In some examples, the expansion suppressing portion 140 extends linearly, but is not limited thereto. For example, the expansion suppressing portion 140 may extend in a broken line shape or a dotted line shape.

The pair of pads 151 and 152 promote pressing of the crotch of the human body Z by the gas chamber 100, and is provided on the ceiling 100a of the gas chamber 100. The pair of pads 151 and 152 are arranged to sandwich the central portion 130a of the third portion 130. The central portion 130a of the third portion 130 is located between the pair of pads 151 and 152. Therefore, the expansion suppressing portion 140 is also located between the pair of pads 151 and 152. Each of the pair of pads 151 and 152 has a substantially rectangular shape, but is not limited thereto. As illustrated in FIG. 6B, when the gas chamber 100 expands, the pad 151 presses a right crotch of the human body Z, and the pad 152 presses a left crotch of the human body Z. Each of the pair of pads 151 and 152 only needs to be simply a portion raised from the ceiling 100a. At least one of pads 151 and 152 may be a chamber or a part of the gas chamber 100. In the latter, at least one of internal space of the pad 151 and internal space of the pad 152 may communicate with the internal space of the first portion 110, the internal space of the second portion 120, and the internal space of the third portion 130. In some examples, each of the pair of pads 151 and 152 is welded to the ceiling 100a, but is not limited thereto. Each of the pair of pads 151 and 152 may be a projecting portion provided in advance on the ceiling 100a. A material of the pair of pads 151 and 152 is not particularly limited, and may be, for example, a sponge covered with a resin film. In this case, the resin film is welded to the ceiling 100a.

The gas supply/discharge port 160 is an opening connected to the hose 2h, and is provided at the bottom 100b of the gas chamber 100. The gas is supplied into the gas chamber 100 or discharged from the gas chamber 100 through the gas supply/discharge port 160. The gas supply/discharge port 160 is provided in the first portion 110, but is not limited thereto. For example, the gas supply/discharge port 160 may be provided in the second portion 120.

Returning to FIGS. 2 and 3, the first cover 21a is a sheet-like member covering the gas chamber group 20a. A size of the first cover 21a may be a size as long as it can cover the gas chamber group 20a when the first lymphatic drainage member 2a is worn on the human body Z. The first cover 21a is deformable according to a shape of the waist or the like of the human body Z. Thus, damage of the first cover 21a caused by expansion of the gas chambers 100 to 104 or the like can be prevented. The first cover 21a is formed of, for example, synthetic fiber and the like.

The first fastener 22a is a member provided to fasten the ends of the first cover 21a in the circumferential direction Q2. The first fastener 22a is a pair of members respectively provided in the axial direction Q1 on a front right side and a front left side of the first cover 21a. The first fastener 22a fastens both ends of a front central portion of the first cover 21a in the circumferential direction Q2 and ends of a front right portion and a front left portion in the circumferential direction Q2 in front of the human body Z. For example, the first fastener 22a fastens the ends of the first cover 21a so that the ends of the gas chambers 100 and 103 in the circumferential direction Q2 overlap each other and the ends of the gas chambers 100 and 104 in the circumferential direction Q2 overlap each other.

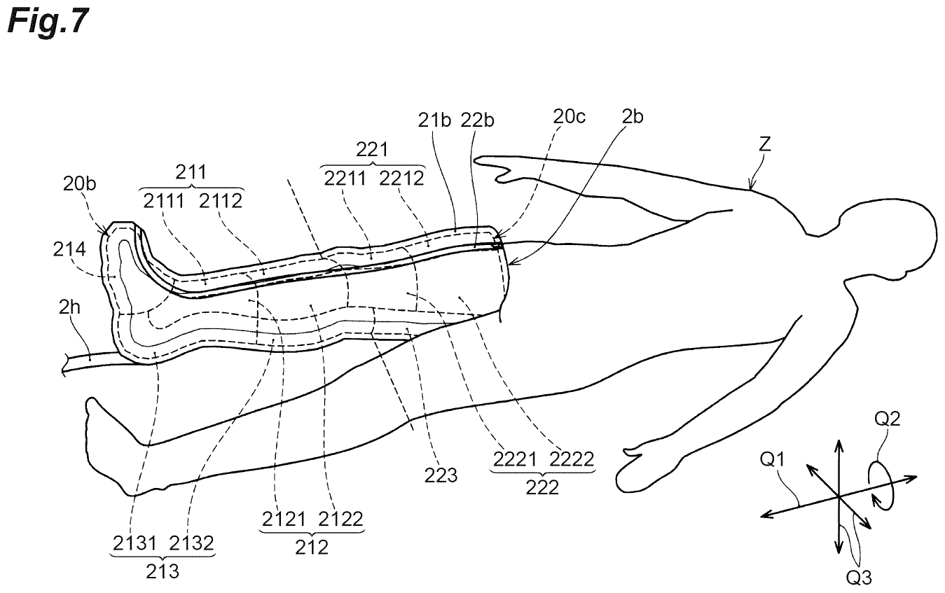

FIG. 7 is a schematic perspective view of the second lymphatic drainage member as viewed from the front. In FIG. 7, the human body Z inserted into the second lymphatic drainage member 2b is drawn by a solid line. As illustrated in FIG. 7, the second lymphatic drainage member 2b is worn in the axial direction Q1 so as to surround the leg of the human body Z in the circumferential direction Q2. A shape of the second lymphatic drainage member 2b is not particularly limited as long as it can be worn on the leg of the human body Z. In some examples, the second lymphatic drainage member 2b has a boot shape, and one end in the axial direction Q1 is bent with respect to the axial direction Q1 so as to extend along up to the toe at an end of the leg of the human body Z. In this case, the second lymphatic drainage member 2b may be positioned on the human body Z when the second lymphatic drainage member 2b is worn on the leg such that a bent portion is along the toe. Therefore, a gas chamber included in the second lymphatic drainage member 2b can be positioned at a desired region of the human body. In some examples, the second lymphatic drainage member 2b is worn on the right leg of the human body Z, but is not limited thereto. The second lymphatic drainage member 2b may be wearable on the right leg and the left leg of the human body Z. In this case, one main device 2 can promote flow of the lymph fluid in both left and right sides of the lower limb of the human body Z.

The second lymphatic drainage member 2b includes gas chamber groups 20b and 20c provided to be adjacent to each other in the axial direction Q1, a second cover 21b surrounding the gas chamber groups 20b and 20c in the circumferential direction Q2, and a second fastener 22b fastening ends of the second cover 21b in the circumferential direction Q2.

Each of the gas chamber groups 20b and 20c has at least two gas chambers arranged in the circumferential direction Q2. Since each of the gas chamber groups 20b and 20c has at least two gas chambers, the second lymphatic drainage member 2b only at a position where it is desired to be pressed in the circumferential direction Q2 can be expanded while avoiding a specific region of the human body Z. In some examples, the gas chamber group 20b includes gas chambers 211 to 213 arranged in the circumferential direction Q2. The gas chamber group 20c includes gas chambers 221 to 223 arranged in the circumferential direction Q2. However, each of the gas chamber groups 20b and 20c may have four or more gas chambers arranged in the circumferential direction Q2.

From the viewpoint of promoting the flow of the lymph fluid, each of the gas chambers 211 to 213 and 221 to 223 may have a plurality of sub-gas chambers that can expand and contract independently of each other. In some examples, the gas chamber 211 is divided into a first distal gas chamber 2111 and a first proximal gas chamber 2112. The gas chamber 212 is divided into a second distal gas chamber 2121 and a second proximal gas chamber 2122. The gas chamber 213 is divided into a third distal gas chamber 2131 and a third proximal gas chamber 2132. Similarly, the gas chamber 221 is divided into a first distal gas chamber 2211 and a first proximal gas chamber 2212. The gas chamber 222 is divided into a second distal gas chamber 2221 and a second proximal gas chamber 2222. The gas chamber 223 remains as one gas chamber without being divided in the axial direction Q1, but may be divided into a plurality of sub-gas chambers. The number of divisions of the gas chambers 211 to 213, 221, and 222 is not particularly limited. At least one of the gas chamber groups 20b and 20c may have only one gas chamber provided in the circumferential direction Q2 at an arbitrary position in the axial direction Q1 separately from the above-described gas chambers. In some examples, the gas chamber group 20b has an end gas chamber 214 (a second gas chamber) adjacent to the gas chambers 211 to 213 and extending over substantially an entire circumference in the circumferential direction Q2. The gas chamber group 20c may also have a gas chamber over substantially the entire circumference in the circumferential direction Q2.

A positional relationship between the gas chamber groups 20b and 20c and the human body Z is not particularly limited as long as each of the gas chamber groups 20b and 20c is positioned at at least one region of the lower limb of the human body Z. In some examples, the second lymphatic drainage member 2b is worn on the human body Z such that the bent portion of the second lymphatic drainage member 2b corresponds to the foot of the human body Z. Thus, the gas chamber groups 20b and 20c are positioned with respect to the lower leg and an upper leg of the human body Z in the axial direction Q1 and the circumferential direction Q2. In this case, the gas chamber 211 is disposed at a position corresponding to an outside of the lower leg (a lower leg outer portion) of the human body Z, the gas chamber 212 is disposed at a position corresponding to an inside of the lower leg (a lower leg inner portion) of the human body Z, the gas chamber 221 is disposed at a position corresponding to an outside of the upper leg (an upper leg outer portion) of the human body Z, and the gas chamber 222 is disposed at a position corresponding to an inside of the upper leg (an upper leg inner portion (near the groin)) of the human body Z. Further, the gas chamber 213 is disposed at a position corresponding to a rear side (a lower leg rear surface) of the lower leg of the human body Z, and the gas chamber 223 is disposed at a position corresponding to a rear side (rear surface) of the upper leg of the human body Z. Furthermore, the end gas chamber 214 is disposed at a position corresponding to the foot of the human body Z so as to cover at least a part of the foot. Note that in some examples, the second lymphatic drainage member 2b is positioned with respect to the human body Z by the end gas chamber 214, but is not limited thereto. For example, the second lymphatic drainage member 2b may be positioned at the leg of the human body Z by being connected to the first lymphatic drainage member 2a by a fastener such as a button.

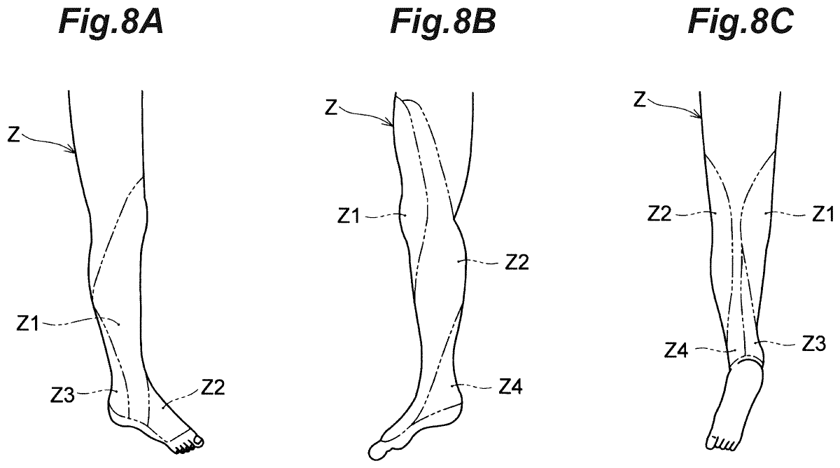

In some examples, the gas chambers 211 and 221 are provided to be adjacent to each other in the axial direction Q1. The gas chambers 212 and 222 are provided to be adjacent to each other in the axial direction Q1. The gas chambers 213 and 223 are provided to be adjacent to each other in the axial direction Q1. In this case, since the gas chambers of the gas chamber groups 20b and 20c are substantially aligned in the axial direction Q1, the gas chambers of the gas chamber groups 20b and 20c are easily positioned on the human body Z so as to correspond to extending directions of lymphatic vessel groups (see lymphatic vessel groups Z1 to Z4 illustrated in FIGS. 8A to 8C) inside the human body Z. Therefore, by expanding and contracting the gas chambers of the second lymphatic drainage member 2b in the extending direction of the lymphatic vessel group, the lymph fluid easily flows to the torso of the human body Z.

In the circumferential direction Q2, a positional relationship between the gas chambers 211 to 213 included in the gas chamber group 20b and a positional relationship between the gas chambers 221 to 223 included in the gas chamber group 20c are not particularly limited. In some examples, ends of the gas chambers 211 and 212, ends of the gas chambers 212 and 213, and ends of the gas chambers 211 and 213 in the circumferential direction Q2 overlap each other. In this case, the gas chambers 211 to 213 are arranged without a gap in the circumferential direction Q2. Therefore, when all of the gas chambers 211 to 213 expand, the human body Z can be exhaustively pressed in the circumferential direction Q2. Further, in some examples, ends of the gas chambers 221 and 222, ends of the gas chambers 222 and 223, and ends of the gas chambers 221 and 223 in the circumferential direction Q2 overlap each other.

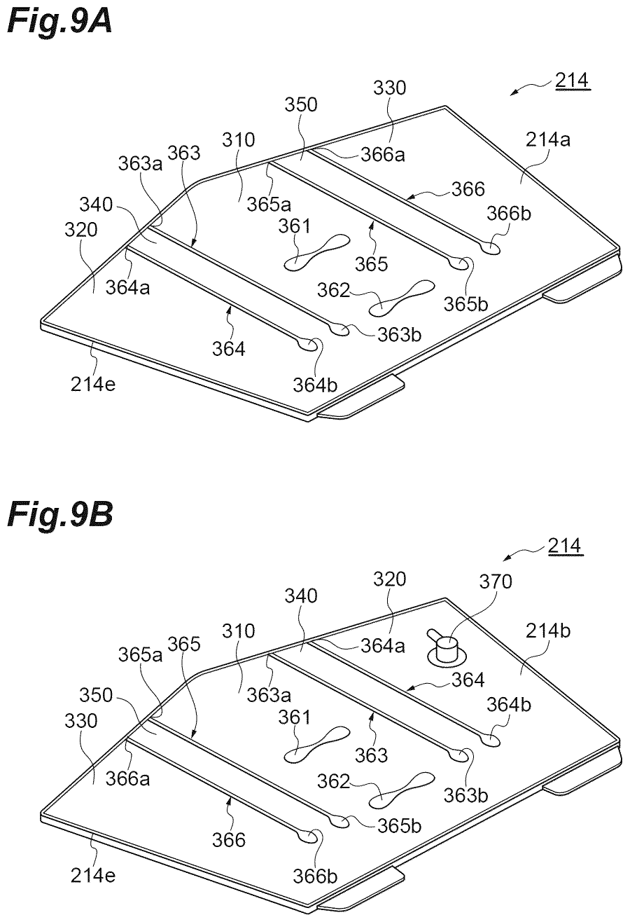

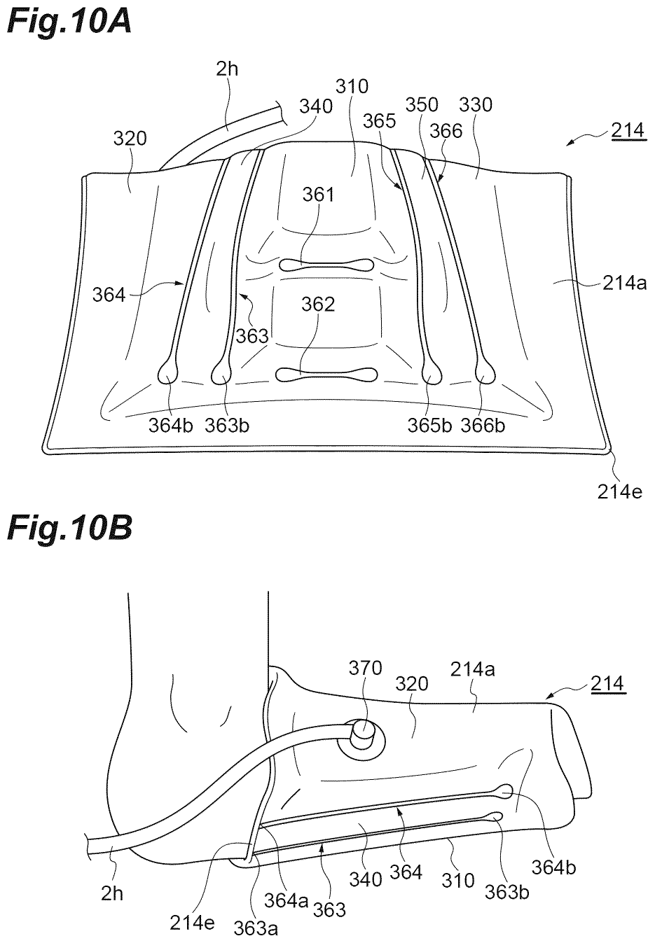

Hereinafter, the end gas chamber 214 will be described in further detail with reference to FIGS. 9A and 9B and FIGS. 10A and 10B. FIG. 9A is a schematic perspective view of the end gas chamber 214 before expansion as viewed from the front, and FIG. 9B is a schematic perspective view of the end gas chamber 214 before expansion as viewed from the bottom surface. FIG. 10A is a schematic perspective view illustrating the end gas chamber 214 after expansion, and FIG. 10B is a schematic side view illustrating the end gas chamber 214 during use. As illustrated in FIGS. 9A and 9B, the end gas chamber 214 is a bag-like member formed by welding and sealing edges of a pair of resin films molded in advance. The end gas chamber 214 is a bag-like member capable of containing gas, and is formed by a ceiling 214a and a bottom 214b which are resin films formed into a predetermined shape. The ceiling 214a comes into contact with the foot of the human body Z when the end gas chamber 214 surrounds the foot. For example, in the end gas chamber 214, an edge 214e of the end gas chamber 214 is formed by welding an edge of the ceiling 214a and an edge of the bottom 214b to each other. The end gas chamber 214 includes a fourth portion 310, a pair of fifth portions 320 and 330, a pair of sixth portions 340 and 350, expansion suppressing portions 361 to 366, and a gas supply/discharge port 370. An internal space of the fourth portion 310, internal spaces of the fifth portions 320 and 330, and internal spaces of the sixth portions 340 and 350 communicate with each other.

The fourth portion 310 is configured to cover at least a part of a sole of the human body Z, and is located between the pair of fifth portions 320 and 330 and between the pair of sixth portions 340 and 350. Before expansion of the end gas chamber 214, the fourth portion 310 has a substantially pentagonal shape, but is not limited thereto. As illustrated in FIG. 10A, when the end gas chamber 214 expands, at least a part of the fourth portion 310 is recessed (details will be described later).

Each of the pair of fifth portions 320 and 330 is a portion configured to cover at least a part of a dorsum pedis of the human body Z, and is provided to sandwich the fourth portion 310. The fifth portion 320 constitutes one end of the end gas chamber 214, and has a substantially quadrangular shape before the expansion of the end gas chamber 214, but is not limited thereto. The fifth portion 330 constitutes the other end of the end gas chamber 214, and has a substantially quadrangular shape before the expansion of the end gas chamber 214, but is not limited thereto. As illustrated in FIG. 10B, when the end gas chamber 214 expands to press the foot of the human body Z, a part of the fifth portion 320 and a part of the fifth portion 330 overlap each other. At this time, the fifth portion 320 is located above the fifth portion 330, but is not limited thereto.

Each of the pair of sixth portions 340 and 350 is a portion configured to cover at least a part of a foot side surface of the human body Z. The sixth portion 340 connects the fourth portion 310 and the fifth portion 320, and is located between the fourth portion 310 and the fifth portion 320. The sixth portion 340 has a substantially quadrangular shape before the expansion of the end gas chamber 214, but is not limited thereto. The sixth portion 350 connects the fourth portion 310 and the fifth portion 330, and is located between the fourth portion 310 and the fifth portion 330. The sixth portion 350 has a substantially quadrangular shape before the expansion of the end gas chamber 214, but is not limited thereto. A width of each of the pair of sixth portions 340 and 350 is smaller than that of the fourth portion 310 and that of each of the pair of fifth portions 320 and 330.

Each of the expansion suppressing portions 361 to 366 is a portion that suppresses expansion of a predetermined portion of the end gas chamber 214. As illustrated in FIG. 10A, when the end gas chamber 214 expands, a portion where the expansion suppressing portions 361 to 366 are provided and a periphery thereof are recessed. Each of the expansion suppressing portions 361 and 362 is a portion (third expansion suppressing portion) that suppresses expansion of a part of the fourth portion 310. Each of the expansion suppressing portions 363 to 366 is a portion (second expansion suppressing portion) that suppresses expansion of any one of the pair of sixth portions 340 and 350. The expansion suppressing portions 363 and 364 suppress expansion of the sixth portion 340. The expansion suppressing portions 365 and 366 suppress expansion of the sixth portion 350.

The expansion suppressing portions 361 and 362 extend in a direction in which the fifth portions 320 and 330 are arranged and are separated from each other. In some examples, the expansion suppressing portion 361 is located at a center of the fourth portion 310. In this case, the expansion suppressing portion 362 is located closer to the edge 214e of the end gas chamber 214 than the expansion suppressing portion 361 and closer to the toe of the human body Z. The expansion suppressing portions 361 and 362 are separated from the edge 214e of the end gas chamber 214. Thus, expansion of an unintended portion is prevented in the fourth portion 310. In each of the expansion suppressing portions 361 and 362, the ceiling 214a and the bottom 214b of the end gas chamber 214 are joined to each other. In some examples, each of the expansion suppressing portions 361 and 362 is formed by welding a part of the ceiling 214a and a part of the bottom 214b of the end gas chamber 214 to each other. From the viewpoint of strength of the expansion suppressing portions 361 and 362 and the like, each of the expansion suppressing portions 361 and 362 has, for example, a substantially figure V-shape, but is not limited thereto. In some examples, when the end gas chamber 214 expands, the expansion suppressing portion 361 overlaps a plantar arch of the human body Z, and the expansion suppressing portion 362 overlaps the toe of the human body Z. Thus, when the end gas chamber 214 expands, the plantar arch and the toe of the human body Z are less likely to be pressed by the end gas chamber 214, so that discomfort given to the human body Z can be reduced. Note that, depending on a size of the foot of the human body Z, a base of the foe of the human body Z may overlap the expansion suppressing portion 361 or may overlap the expansion suppressing portion 362.

The expansion suppressing portion 363 and 364 extend in a direction intersecting the direction in which the fifth portions 320 and 330 are arranged and are separated from each other. The expansion suppressing portion 363 is a linear portion extending to partition the fourth portion 310 and the sixth portion 340. The expansion suppressing portion 364 is a linear portion extending to partition the fifth portion 320 and the sixth portion 340. One end 363a of the expansion suppressing portion 363 and one end 364a of the expansion suppressing portion 364 are connected to the edge 214e of the end gas chamber 214. Thus, the expansion suppressing portions 363 and 364 extend to approach the expansion suppressing portions 361 and 362, and the gas is less likely to be supplied to the sixth portion 340. On the other hand, the other end 363b of the expansion suppressing portion 363 and the other end 364b of the expansion suppressing portion 364 are separated from the edge 214e of the end gas chamber 214. Thus, communication between the internal space of the fourth portion 310 and the internal space of the fifth portion 320 is secured. In each of the expansion suppressing portions 363 and 364, the ceiling 214a and the bottom 214b of the end gas chamber 214 are joined to each other. In some examples, each of the expansion suppressing portions 363 and 364 is formed by welding a part of the ceiling 214a and a part of the bottom 214b of the end gas chamber 214 to each other. From the viewpoint of the strength and the like of the expansion suppressing portion 363, a width of the other end 363b of the expansion suppressing portion 363 is larger than that of a portion different from the other end 363b of the expansion suppressing portion 363. Similarly, a width of the other end 364b of the expansion suppressing portion 364 is larger than that of a portion different from the other end 364b of the expansion suppressing portion 364. Therefore, a gap between the other ends 363b and 364b included in a region communicating with the fourth portion 310 and the like in the internal space of the sixth portion 340 is narrowed. Therefore, since the gas is less likely to be supplied to the sixth portion 340, the sixth portion 340 is less likely to expand than the fourth portion 310 and the fifth portion 320. From the viewpoint of suppressing the expansion of the sixth portion 340, the expansion suppressing portions 363 and 364 extend linearly.

The expansion suppressing portion 365 and 366 extend in the direction intersecting the direction in which the fifth portions 320 and 330 are arranged and are separated from each other. The expansion suppressing portion 365 is a linear portion extending to partition the fourth portion 310 and the sixth portion 350. The expansion suppressing portion 366 is a linear portion extending to partition the fifth portion 330 and the sixth portion 350. One end 365a of the expansion suppressing portion 365 and one end 366a of the expansion suppressing portion 366 are connected to the edge 214e of the end gas chamber 214. Thus, the expansion suppressing portions 365 and 366 extends to approach the expansion suppressing portions 361 and 362, and the gas is less likely to be supplied to the sixth portion 350. On the other hand, the other end 365b of the expansion suppressing portion 365 and the other end 366b of the expansion suppressing portion 366 are separated from the edge 214e of the end gas chamber 214. Thus, communication between the internal space of the fourth portion 310 and the internal space of the fifth portion 330 is secured. In each of the expansion suppressing portions 365 and 366, the ceiling 214a and the bottom 214b of the end gas chamber 214 are joined to each other. In some examples, each of the expansion suppressing portions 365 and 366 is formed by welding a part of the ceiling 214a and a part of the bottom 214b of the end gas chamber 214 to each other. From the viewpoint of the strength and the like of the expansion suppressing portion 365, a width of the other end 365b of the expansion suppressing portion 365 is larger than that of a portion different from the other end 365b of the expansion suppressing portion 365. Similarly, a width of the other end 366b of the expansion suppressing portion 366 is larger than that of a portion different from the other end 366b of the expansion suppressing portion 366. Therefore, a gap between the other ends 365b and 366b included in a region communicating with the fourth portion 310 and the like in the internal space of the sixth portion 350 is narrowed. Therefore, since the gas is less likely to be supplied to the sixth portion 350, the sixth portion 350 is less likely to expand than the fourth portion 310 and the fifth portion 330. From the viewpoint of suppressing the expansion of the sixth portion 350, the expansion suppressing portions 365 and 366 extend linearly.

The gas supply/discharge port 370 is an opening connected to the hose 2h, and is provided at the bottom 214b of the end gas chamber 214. The gas is supplied into the end gas chamber 214 or discharged from the end gas chamber 214 through the gas supply/discharge port 370. The gas supply/discharge port 370 is provided in the fifth portion 320, but is not limited thereto. For example, the gas supply/discharge port 370 may be provided in the fifth portion 330.

Returning to FIG. 7, the second cover 21b has a sheet-like shape similarly to the first cover 21a. A size of the second cover 21b only needs to cover the gas chamber groups 20b and 20c when the second lymphatic drainage member 2b is worn on the human body Z. The second cover 21b is deformable according to a shape of the leg or the like of the human body Z. Thus, damage of the second cover 21b caused by expansion of the gas chambers 211 to 213 and 221 to 223 or the like can be prevented. The second cover 21b is formed of, for example, synthetic fiber and the like.

The second fastener 22b is provided to fasten the ends of the second cover 21b in the circumferential direction Q2. When the ends of the second cover 21b are fastened to each other by the second fastener 22b, the second lymphatic drainage member 2b developed can be closed in a substantially boot shape. Thus, the second lymphatic drainage member 2b can be easily worn on the leg of the human body Z. In some examples, the second fastener 22b is provided in the axial direction Q1 at both ends of the second cover 21b in the circumferential direction Q2. For example, one end and the other end of the second cover 21b in the circumferential direction Q2 are fastened in front of the leg of the human body Z. In this case, after the leg of the human body Z is placed at a center of the second lymphatic drainage member 2b in a state where the second lymphatic drainage member 2b is developed, the second lymphatic drainage member 2b can be worn to surround the leg of the human body Z. In some examples, the second fastener 22b is provided on the second cover 21b so that the gas chamber 211 and the gas chamber 212 extend outward from the both ends of the second cover 21b in the circumferential direction Q2 when the second lymphatic drainage member 2b is developed. Thus, the second fastener 22b can fasten the ends of the second cover 21b so that the ends of the gas chamber 211 and the gas chamber 212 in the circumferential direction Q2 overlap each other. Note that the second fastener 22b is a line fastener, but is not limited thereto. For example, the second fastener 22b may be a plurality of buttons arranged side by side in the axial direction Q1.

Returning to FIG. 1, the gas supply/discharge system 3 is a system that supplies or discharges the gas to or from each of the first lymphatic drainage member 2a and the second lymphatic drainage member 2b included in the main device 2. The gas supply/discharge system 3 is detachably fluidly connected to the main device 2 (for example, the hose 2h of the main device 2) via a connector 3a.

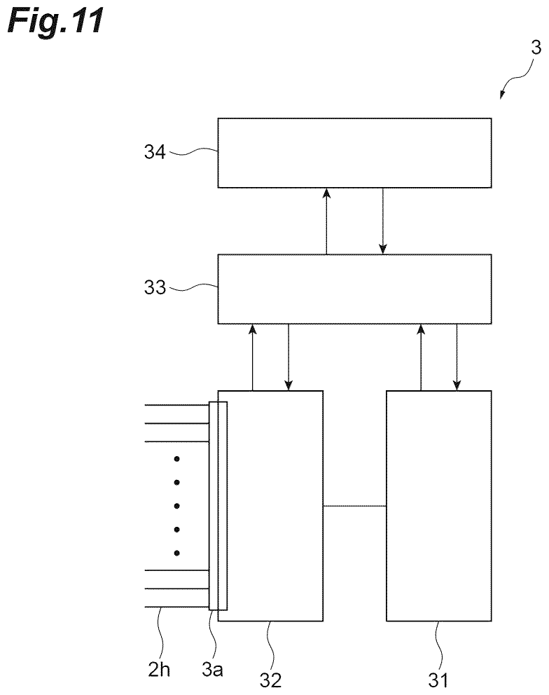

FIG. 11 is a schematic configuration diagram of the gas supply/discharge system. As illustrated in FIG. 11, the gas supply/discharge system 3 includes a gas supply apparatus 31 that supplies the gas, a flow path switching apparatus 32 that switches a flow path of the gas, a control apparatus 33 that controls the gas supply apparatus 31 and the flow path switching apparatus 32, and an operation unit 34 for operating the gas supply/discharge system 3. In the gas supply/discharge system 3, the control apparatus 33 may control operations of the gas supply apparatus 31 and the flow path switching apparatus 32 based on an input to the operation unit 34 by a user of the main device 2, to supply the gas to the main device 2 and discharge the gas from the main device 2. Concrete configurations of the gas supply apparatus 31, the flow path switching apparatus 32, the control apparatus 33, and the operation unit 34 are not particularly limited as long as the above-described functions can be exhibited. As the gas supply apparatus 31, for example, a known air pump or the like can be used. As the flow path switching apparatus 32, for example, a known compressed air distributor in which a branch pipe and an electromagnetic valve are combined can be used. Examples of the control apparatus 33 include a controller in which a control program such as a kneading step for performing massage to be described later is recorded. The controller can control the operations of the gas supply apparatus 31 and the flow path switching apparatus 32 based on a control program described to expand and contract the gas chambers in the main device 2 in a desired order. As the operation unit 34, for example, a touch panel display apparatus or the like can be used.

The gas supply/discharge system 3 can supply the gas to the main device 2 or discharge the gas from the main device 2 in various orders based on the control program. For example, in order to promote flow of body fluid from the lower limb toward the torso of the human body Z, the gas supply/discharge system 3 supplies the gas to the gas chamber group 20b and then supplies the gas to the gas chamber group 20c. In some examples, in order to alleviate symptoms of lymphedema of the lower limb of the human body Z, the lymph fluid is intended to flow from the lower limb toward the torso of the human body Z using the lymphatic drainage device 1. As illustrated in FIGS. 8A to 8C, the lymphatic vessel groups Z1 to Z4 in the lower limb of the human body Z are divided into the lymphatic vessel group Z1 on an anterior outer side of the leg, the lymphatic vessel group Z2 on an anterior inner side of the leg, the lymphatic vessel group Z3 on a posterior outer side of the leg, and the lymphatic vessel group Z4 on a posterior inner side of the leg. In the case of lymphedema of the lower limb, it is often seen that one of the lymphatic vessel group Z1 on the anterior outer side of the leg and the lymphatic vessel group Z2 on the anterior inner side of the leg is damaged in an initial disease state. In this case, even if a region of the human body Z in which damaged lymphatic vessel groups Z1 and Z2 are present is simply pressed by the main device 2, the lymph fluid is unlikely to flow from the lymphatic vessel groups Z1 and Z2 toward the torso.

Therefore, in some examples, by changing the order of supplying the gas to the gas chamber groups 20b and 20c in the circumferential direction Q2, the lymph fluid retained in the lower limb of the human body Z may be flown toward the torso. Examples of a method for flowing the lymph fluid toward the torso include implementation of the order of supplying the gas to the gas chamber and the order of discharging the gas from the gas chamber (also referred to as the “kneading step”) using the control program disclosed in Japanese Patent No. 7,289,557 or Japanese Patent No. 7,356,770. That is, Japanese Patent No. 7,289,557 or Japanese Patent No. 7,356,770 incorporated herein by reference describes examples of a method for flowing the lymph fluid. Note that in the following description, a state in which a vascular such as a lymphatic vessel is damaged may be simply referred to as “non-normal”, and a state in which the vascular such as the lymphatic vessel is normal or a state in which the vascular is less damaged may be simply referred to as “normal”.

By performing the kneading step using the lymphatic drainage device 1 according to some examples, the main device 2 only at a position to be pressed in the human body Z can be expanded while avoiding a specific region of the human body Z. Thus, the lymph fluid retained in the lower limb of the human body Z easily flows toward the torso of the human body Z through vascular groups such as normal lymphatic vessel groups Z1 to Z4 of the human body Z. That is, the same operational effects as those disclosed in Japanese Patent No. 7289557 or Japanese Patent No. 7356770 can be exhibited.

Here, Japanese Patent No. 7289557 and Japanese Patent No. 7356770 disclose that the gas is supplied to the first gas chamber positioned at the crotch of the human body Z before supply of a high-pressure gas to all the gas chambers of a massage device configured to cover the leg of the human body from the viewpoint of suppressing inflow of the lymph fluid from the leg to the crotch through the groin due to execution of the kneading step. However, neither Japanese Patent No. 7,289,557 nor Japanese Patent No. 7,356,770 discloses a concrete configuration of the first gas chamber. Usually, an expansion rate of a bag containing the fluid such as the gas is larger toward a center of the bag. Therefore, since the first gas chamber also expands most at a center of the crotch, the crotch is not sufficiently pressed by the first gas chamber. Therefore, in the prior art, even if the gas is supplied to the first gas chamber positioned at the crotch of the human body Z before the high-pressure gas is supplied to all the gas chambers of the massage device configured to cover the leg of the human body, the inflow of the lymph fluid to the crotch and eventually a pubic region may not be prevented.

In contrast, in the lymphatic drainage device 1 according to some examples, the gas chamber 100 included in the first lymphatic drainage member 2a includes the first portion 110 configured to cover at least a part of the lower abdomen of the human body Z, the second portion 120 extending along the gluteal cleft of the human body Z, and the third portion 130 located between the first portion 110 and the second portion 120 and configured to cover the crotch of the human body Z. Here, when the gas chamber 100 expands, at least a part of the central portion 130a of the third portion 130 is recessed. Thus, both sides of the crotch are favorably pressed by the third portion 130 of the gas chamber 100. Therefore, for example, the gas chamber 100 expands before the gas is supplied to all of the gas chambers 211 to 213 and 221 to 223 included in the second lymphatic drainage member 2b, so that inflow of the lymph fluid from one lower limb of the human body Z toward the torso (in particular, an axillary region) to the crotch, the pubic region, and the opposite lower limb can be favorably prevented by the second lymphatic drainage member 2b. Therefore, the flow of the lymph fluid to an intended location by using the lymphatic drainage device 1 according to some examples can be promoted.

In some examples, the gas chamber 100 may expand before the gas is supplied to the gas chamber group 20c. In this case, the gas may be supplied to all of the gas chambers 211 to 213 and the end gas chamber 214 included in the gas chamber group 20b, or the gas may be supplied to at least one of the gas chambers 211 to 213 and the end gas chamber 214. Alternatively, the gas chamber 100 may expand before the gas is supplied to the gas chamber groups 20b and 20c. In another example, the gas chamber 100 may expand before the gas is supplied to all of the gas chambers 221 to 223 included in the gas chamber group 20c.

In some examples, when the gas chamber 100 expands, at least a portion close to the first portion 110 in the central portion 130a of the third portion 130 is recessed. Therefore, when the gas chamber 100 expands, the first portion 110 can favorably press the crotch and the groin. Therefore, the inflow of the lymph fluid from the one lower limb toward the torso to the crotch of the human body Z, the pubic region, and the opposite lower limb can be more favorably prevented.

In some examples, when the gas chamber 100 expands, at least a part of the central portion 110a of the first portion 110 is recessed. In addition, when the gas chamber 100 expands, the pubic region of the human body Z is less likely to be pressed by the gas chamber 100. Therefore, the discomfort given to the human body Z by the lymphatic drainage device 1 can be reduced.

In some examples, the gas chamber 100 has the expansion suppressing portion 140 extending from the central portion 110a of the first portion 110 toward the central portion 130a of the third portion 130. Therefore, when the gas chamber 100 expands, the gas chamber 100 can more favorably press the crotch and the groin.

In some examples, the gas chamber 100 has the pair of pads 151 and 152 provided on the ceiling 100a, and the central portion 130a of the third portion 130 is located between the pair of pads 151 and 152. Therefore, when the gas chamber 100 expands, the both sides of the crotch are more favorably pressed by the pair of pads 151 and 152. Therefore, the inflow of the lymph fluid from the one lower limb toward the torso to the crotch of the human body Z, the pubic region, and the opposite lower limb can be more favorably prevented.

In some examples, the gas chamber group 20b has the end gas chamber 214 configured to cover at least a part of the foot of the human body Z, the end gas chamber 214 has the fourth portion 310 configured to cover at least a part of the sole of the human body Z, the pair of fifth portions 320 and 330 configured to cover at least a part of the dorsum pedis of the human body Z, the pair of sixth portions 340 and 350 configured to cover at least a part of the foot side surface of the human body Z, and the expansion suppressing portions 363 to 366 suppressing expansion of the pair of sixth portions 340 and 350, the sixth portion 340 connects the fourth portion 310 and the fifth portion 320, and the sixth portion 350 connects the fourth portion 310 and the fifth portion 330. Therefore, when the end gas chamber 214 expands, the foot side surface of the human body Z is less likely to be pressed.

In some examples, the end gas chamber 214 has the expansion suppressing portions 361 and 362 suppressing expansion of a part of the fourth portion 310. Therefore, the intended portion of the sole of the human body Z can be selectively pressed.

The gas-type lymphatic drainage device according to one aspect of the present disclosure is, for example, as described in the following [1] to [9], and has been described in detail based on the above examples.
[1]

A gas-type lymphatic drainage device for flowing lymph fluid of a lower limb of a human body toward a torso by using a gas, the gas-type lymphatic drainage device including:
a first lymphatic drainage member having a pants-like shape;
a second lymphatic drainage member having a boot-like shape, the second lymphatic drainage member being connected to the first lymphatic drainage member; and
a gas supply/discharge system configured to supply or discharge a gas to or from each of the first lymphatic drainage member and the second lymphatic drainage member, in which
the first lymphatic drainage member includes a first gas chamber expandable and contractible,
the second lymphatic drainage member includes a gas chamber group containing gas chambers independently expandable and contractible,
the first gas chamber includes a first portion configured to cover at least a part of a lower abdomen of the human body, a second portion configured to extend along a gluteal cleft of the human body, and a third portion located between the first portion and the second portion, the third portion being configured to cover a crotch of the human body, and
when the first gas chamber expands, at least a part of a central portion of the third portion is recessed.
[2]

The gas-type lymphatic drainage device according to [1], in which, when the first gas chamber expands, at least a portion close to the first portion in the central portion of the third portion is recessed.
[3]

The gas-type lymphatic drainage device according to [1] or [2], in which, when the first gas chamber expands, at least a part of a central portion of the first portion is recessed.
[4]

The gas-type lymphatic drainage device according to any one of [1] to [3], in which the first gas chamber includes an expansion suppressing portion extending from a central portion of the first portion toward the central portion of the third portion.
[5]

The gas-type lymphatic drainage device according to [4], in which, in the expansion suppressing portion, a ceiling and a bottom of the first gas chamber are joined to each other.
[6]

The gas-type lymphatic drainage device according to any one of [1] to [5], in which
the first gas chamber includes a pair of pads provided on a ceiling of the first gas chamber, and
the central portion of the third portion is located between the pair of pads.
[7]

The gas-type lymphatic drainage device according to any one of [1] to [6], in which
the gas chamber group includes a second gas chamber configured to cover at least a part of a foot of the human body,
the second gas chamber includes a fourth portion configured to cover at least a part of a sole of the human body, a fifth portion configured to cover at least a part of a dorsum pedis of the human body, a sixth portion configured to cover at least a part of a foot side surface of the human body, and a second expansion suppressing portion configured to suppress expansion of the sixth portion, and
the sixth portion connects the fourth portion and the fifth portion.
[8]

The gas-type lymphatic drainage device according to [7], in which in the second expansion suppressing portion, a ceiling and a bottom of the second gas chamber are joined to each other.
[9]

The gas-type lymphatic drainage device according to [7] or [8], in which the second gas chamber includes a third expansion suppressing portion configured to suppress expansion of a part of the fourth portion.

It is to be understood that not all aspects, advantages and features described herein may necessarily be achieved by, or included in, any one particular example. Indeed, having described and illustrated various examples herein, it should be apparent that other examples may be modified in arrangement and detail.

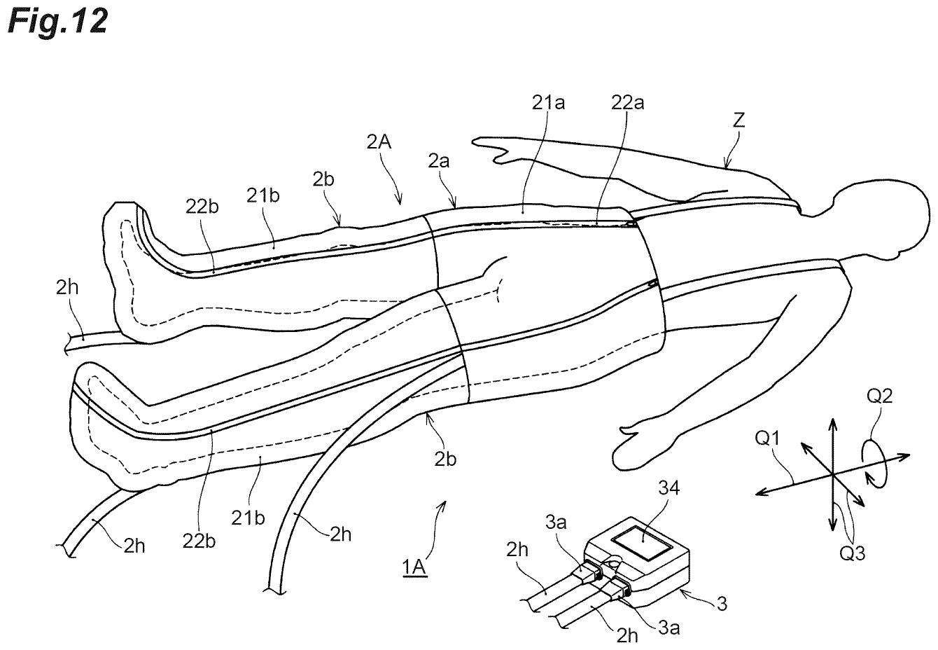

FIG. 12 is a schematic perspective view illustrating the lymphatic drainage device according to another example. As illustrated in FIG. 12, a main device 2A of a lymphatic drainage device 1A includes the first lymphatic drainage member 2a and two second lymphatic drainage members 2b and 2b. In this case, since the main device 2A can be simultaneously worn on the both legs of the human body Z, the kneading step can be simultaneously performed on the both legs of the human body Z. Even in the case of using such a main device 2A, the inflow of the lymph fluid to the crotch of the human body Z may be prevented when the lymph fluid flows from the lower limbs of the human body Z to the torso.

In some examples, the end gas chamber has the pair of fifth portions and the pair of sixth portions, but is not limited thereto. For example, the end gas chamber may be utilized to be wound around a part of the foot of the human body, and may have the fourth portion, one fifth portion, and one sixth portion. In this case, the sixth portion is located on the foot side surface.

In some examples, the main device is configured to cover only a lower body of the human body, but is not limited thereto. For example, the main device may have a whole body suit shape integrated along the left and right legs, the waist, and an upper body.

What is claimed is:

1. A gas-type lymphatic drainage device comprising:
a first lymphatic drainage member having a pants-like shape;
a second lymphatic drainage member having a boot-like shape, the second lymphatic drainage member being connected to the first lymphatic drainage member; and
a gas supply/discharge system configured to supply or discharge a gas to or from each of the first lymphatic drainage member and the second lymphatic drainage member,
wherein the first lymphatic drainage member includes a first gas chamber that is expandable and contractible,
wherein the second lymphatic drainage member includes a gas chamber group containing gas chambers independently expandable and contractible,
wherein the first gas chamber includes a first portion configured to cover at least a part of a lower abdomen of a human body, a second portion configured to extend along a gluteal cleft of the human body, and a third portion located between the first portion and the second portion, the third portion being configured to cover a crotch of the human body, and
wherein, when the first gas chamber expands, at least a part of a central portion of the third portion is recessed.

2. The gas-type lymphatic drainage device according to claim 1, wherein, when the first gas chamber expands, at least a portion close to the first portion in the central portion of the third portion is recessed.

3. The gas-type lymphatic drainage device according to claim 1, wherein, when the first gas chamber expands, at least a part of a central portion of the first portion is recessed.

4. The gas-type lymphatic drainage device according to claim 1, wherein the first gas chamber includes an expansion suppressing portion extending from a central portion of the first portion toward the central portion of the third portion.

5. The gas-type lymphatic drainage device according to claim 4, wherein, in the expansion suppressing portion, a ceiling and a bottom of the first gas chamber are joined to each other.

6. The gas-type lymphatic drainage device according to claim 1,
wherein the first gas chamber includes a pair of pads on a ceiling of the first gas chamber, and
wherein the central portion of the third portion is located between the pair of pads.

7. The gas-type lymphatic drainage device according to claim 1,
wherein the gas chamber group includes a second gas chamber configured to cover at least a part of a foot of the human body,
wherein the second gas chamber includes a fourth portion configured to cover at least a part of a sole of the human body, a fifth portion configured to cover at least a part of a dorsum pedis of the human body, a sixth portion configured to cover at least a part of a foot side surface of the human body, and a second expansion suppressing portion configured to suppress expansion of the sixth portion, and
wherein the sixth portion connects the fourth portion and the fifth portion.

8. The gas-type lymphatic drainage device according to claim 7, wherein, in the second expansion suppressing portion, a ceiling and a bottom of the second gas chamber are joined to each other.

9. The gas-type lymphatic drainage device according to claim 7, wherein the second gas chamber includes a third expansion suppressing portion configured to suppress expansion of a part of the fourth portion.

10. A gas-type lymphatic drainage device comprising:
a lymphatic drainage member; and
a gas supply/discharge system configured to supply or discharge a gas to or from the lymphatic drainage member,
wherein the lymphatic drainage member includes a gas chamber that is expandable and contractible,
wherein the gas chamber includes a first portion configured to cover at least a part of a lower abdomen of a human body, a second portion configured to extend along a gluteal cleft of the human body, and a third portion located between the first portion and the second portion, the third portion being configured to cover a crotch of the human body, and
wherein, when the gas chamber expands, at least a part of a central portion of the third portion is recessed.

11. The gas-type lymphatic drainage device according to claim 10, wherein, when the gas chamber expands, at least a portion close to the first portion in the central portion of the third portion is recessed.

12. The gas-type lymphatic drainage device according to claim 10, wherein, when the gas chamber expands, at least a part of a central portion of the first portion is recessed.

13. The gas-type lymphatic drainage device according to claim 1, wherein the gas chamber includes an expansion suppressing portion extending from a central portion of the first portion toward the central portion of the third portion.

14. The gas-type lymphatic drainage device according to claim 13, wherein, in the expansion suppressing portion, a ceiling and a bottom of the gas chamber are joined to each other.

15. The gas-type lymphatic drainage device according to claim 1,
wherein the gas chamber includes a pair of pads on a ceiling of the gas chamber, and
wherein the central portion of the third portion is located between the pair of pads.

16. A lymphatic drainage device comprising:
a main member configured to surround a periphery of a crotch of a human body; and
a gas chamber group surrounded by the main member, the gas chamber group including a gas chamber configured to extend across a front and rear of the human body,
wherein the gas chamber includes a first portion configured to cover at least a part of a lower abdomen of the human body, a second portion configured to extend along a gluteal cleft of the human body, and a third portion located between the first portion and the second portion, the third portion being configured to cover a crotch of the human body, and
wherein, when the gas chamber expands, at least a part of a central portion of the third portion is recessed.

17. The lymphatic drainage device according to claim 16, wherein, when the gas chamber expands, at least a portion close to the first portion in the central portion of the third portion is recessed.

18. The lymphatic drainage device according to claim 16, wherein, when the gas chamber expands, at least a part of a central portion of the first portion is recessed.

19. The lymphatic drainage device according to claim 16, wherein the gas chamber includes an expansion suppressing portion extending from a central portion of the first portion toward the central portion of the third portion.

20. The lymphatic drainage device according to claim 19, wherein, in the expansion suppressing portion, a ceiling and a bottom of the gas chamber are joined to each other.
